(19) United States
(12) Patent Application Publication
(10) Pub. No.: US 2009/0210552 A1
(43) Pub. Date: Aug. 20, 2009

(54) Facilitating access to IPTV content using a portable device while roaming

(75) Inventors: Timucin Ozugur, Fairview, TX (US); Chao Kan, Frisco, TX (US); Lubo Tancevski, Dallas, TX (US)

Correspondence Address: ALCATEL-LUCENT, C/O GALASSO & ASSOCIATES, LP, P. O. BOX 26503, AUSTIN, TX, 78755-0503, US

(73) Assignee: ALCATEL LUCENT

(21) Appl. No.: 12/070,177

(22) Filed: Feb. 15, 2008

(51) Int. Cl. G06F 15/16

(52) U.S. Cl. 709/232

(57) ABSTRACT

An IPTV system architecture has an IPTV system and an edge service router connected to the IPTV system. The IPTV system is configured for facilitating delivery of IPTV content dependent upon commands formatted in accordance with a communications protocol supported by the IPTV system. The edge service router is coupled to the IPTV system and includes an IPTV Gateway apparatus. The IPTV Gateway apparatus is configured for receiving commands issued by IPTV subscriber networking devices for affecting IPTV content delivered thereto, for translating the commands from a format in accordance with a communications protocol not supported by the IPTV system to the supported communications protocol, and for providing the translated commands to the IPTV system.

### FIELD OF THE DISCLOSURE

The disclosures made herein relate generally to IPTV systems and methodologies and, more particularly, to systems and methods configured for facilitating access to IPTV (Internet Protocol Television) content using a portable device while roaming.

### BACKGROUND

In current IPTV systems, IPTV user access IPTV content at their physical premises (e.g., home) through the use of a STB. The STB are connected to a DSLAM (Digital Subscriber Line Access Multiplexer), most likely via a Residential Gateway (RG). Commands from the STB (e.g., channel change requests) are transmitted upstream toward content serving equipment through the DSLAM and the IPTV content is transmitted from the content serving equipment downstream through the DSLAM toward the STB. In an IPTV infrastructure that supports IGMP (Internet Group Management Protocol), to see IPTV content on a desired channel, IGMP is used to join a multicast tree for the desired channel. Each channel is a different multicast tree. For example, the STB sends an IGMP Join message to the DSLAM, and the DSLAM proxies an IGMP Join message to a CO (central office) equipment, and so on.

For any number of reasons, the IPTV user may have the need or desire to access IPTV content while at a location away from their STB (i.e., while roaming). For example, in some cases, such access might be desired or needed from a roamable networking device capable of accessing a network different than their IPTV system, but through which the IPTV system can be accessed. Examples of such roamable networking devices include, but are not limited to, a mobile/cell phone, a wireless PDA, a laptop computer with network access card, and the like. Examples of such different networks include, but are not limited to, mobile device networks (e.g., a wireless telecommunication network), the Internet and the like.

However, neither the Internet nor mobile device networks support IGMP. More specifically, they are not IGMP-compatible networks and, thus, they cannot communicate IGMP-formatted commands for affecting IPTV content transmitted for reception by a networking device (roamable or otherwise) of an IPTV subscriber. This means that they lack multicasting capabilities necessary for allowing IPTV content of an IGMP-based IPTV system to be accessed via such networks using a roamable networking device. Accordingly, a significant limitation of current IPTV systems that rely upon IGMP for enabling access of IPTV content is that roamable networking devices that do not support IGMP and/or that communicate via a network that does not support IGMP cannot be used to access IPTV content.

Various non-IPTV solutions for allowing a user to access televised video content using a mobile device such as a cell phone are known. Examples of such solutions include, but are not limited to, solutions based on Forward Link Only (FLO) technology and solutions based on Digital Video Broadcasting-Handheld (DVB-H) technology. While such solutions do allow a user to access televised video content using a mobile device, they exhibit limitations that adversely impact their practicality, desirability and/or usefulness. For example, video delivery solutions based on FLO technology and DVB-H technology are limited in the number of video channels they support, offering only a fraction of the number of channels available via a typical IPTV system.

Sling Media offers a network interface solution referred to as SLINGBOX that allows roaming Internet users to access live TV content using an Internet-enabled device. However, this solution is not practical or configured for accessing IPTV content using a portable device. One reason for such impracticality is that using the SLINGBOX solution for accessing IPTV content using a portable device will create excess bandwidth at the access point, where bandwidth resources are already limited.

In an Internet Protocol Multi-Media Subsystem (IMS) based IPTV system, a mobile user can access live IPTV content using a wireless device (e.g., a cell phone). Such access is facilitated using a messaging protocol such as, for example, Session Initiation Protocol (SIP) in combination with a streaming protocol such as, for example Real Time Protocol (RTP), Real Time Control Protocol (RTCP) and/or Real Time Streaming Protocol (RTSP). However, one limitation of such an IMS-based IPTV system is challenges in implementing or, possibly, omission of multicasting functionality. IMS-based IPTV systems do not include an IGMP mechanism for facilitating IPTV users joining a multicast tree associated with desired IPTV content.

Therefore, a system and methodology configured in a manner for allowing IPTV content of an IGMP-based IPTV system to be accessed using a roamable networking device that does not support IGMP and/or that communicates via a network that does not support IGMP, and in a manner that overcomes limitation associated with known approaches for facilitating access of IPTV content would be advantageous, desirable and useful.

### SUMMARY OF THE DISCLOSURE

Embodiments of the present invention allow IPTV subscribers to access IPTV content via their mobile devices or PCs while roaming. In this manner, IPTV subscribers with roamable networking devices that do not support an IPTV network compatible communication protocol can access unlimited number of channels via their IPTV system subscription. Beneficially, such embodiments allow IPTV content to be accessed using roamable networking devices in a manner that is more cost effective than other known approaches and in a manner that minimizes waste of bandwidth within the IPTV network. In this manner, the present invention overcomes a number of limitations associated with known approaches for accessing IPTV content using roamable networking devices.

In one embodiment of the present invention, a computer-implemented method comprises a plurality of operations. An operation is performed for receiving a command intended to affect IPTV content transmitted from an IPTV system for reception by a networking device of an IPTV subscriber. The received command is received by an IPTV Gateway apparatus located between the IPTV system and a network serving the networking device. The received command is formatted in accordance with a communications protocol not supported by the IPTV system. After receiving the command, an operation is performed for translating the received command to a format in accordance with a communications protocol supported by the IPTV system. Such translating is performed by the IPTV Gateway apparatus. After translating the command, an operation is performed for providing the translated command to the IPTV system. Such providing is facilitated by the IPTV Gateway apparatus.

In another embodiment of the present invention, an IPTV network architecture comprises an IPTV system and an edge service router. The IPTV system is configured for facilitating delivery of IPTV content dependent upon commands formatted in accordance with a communications protocol supported by the IPTV system. The edge service router is coupled to the IPTV system and includes an IPTV Gateway apparatus. The IPTV Gateway apparatus is configured for receiving commands issued by IPTV subscriber networking devices for affecting IPTV content delivered thereto, for translating the commands from a format in accordance with a communications protocol not supported by the IPTV system to the supported communications protocol, and for providing the translated commands to the IPTV system.

In another embodiment of the present invention, an IPTV Gateway apparatus is configured for: i.) determining a format of a command intended to affect IPTV content transmitted from an IPTV system for reception by a networking device of an IPTV subscriber; ii.) translating the command to a format in accordance with a communications protocol supported by the IPTV system in response to determining that the command is formatted in accordance with a communications protocol not supported by the IPTV system; and iii.) providing the translated command to the IPTV system.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a diagrammatic view showing an IPTV network in accordance with an embodiment of the present invention.

FIG. 2 is a flow chart view showing a method for facilitating IPTV Gateway functionality in accordance with an embodiment of the present invention.

### DETAILED DESCRIPTION OF THE DRAWING FIGURES

IPTV networks implemented in accordance with embodiments of the present invention include an IPTV Gateway that has the functionality of translating commands (e.g., messages) configured in accordance with a communications protocol not supported by the IPTV network to commands configured in accordance with a communications protocol supported by the IPTV network. For example, such IPTV network implementations can be configured to provide the functionality of translating commands formatted in accordance with a non-supported communications protocol (e.g., SIP/RTSP/RTP/RTCP) to a command formatted in accordance with a supported communications protocol (e.g., IGMP) thereby affecting a manner in which IPTV content is multicast. In this manner, IPTV commands sent via a network or device that does not support a communications protocol that is compatible with IPTV network can still be used for affecting delivery of IPTV content from the IPTV network such as in the case of IPTV subscribers accessing IPTV content from their mobile devices or PCs via 3g wireless and Internet, respectively, while roaming outside their home.

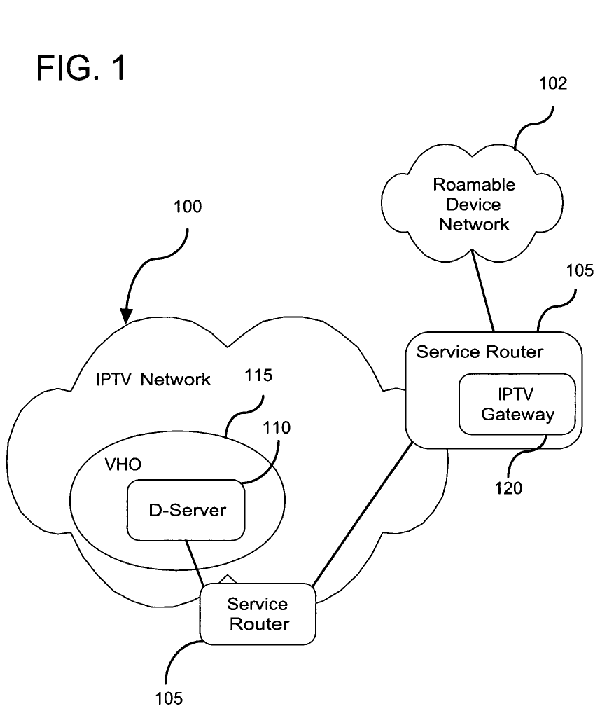

Referring now to FIG. 1, an IPTV network 100 in accordance with an embodiment of the present invention is shown. The IPTV network 100 allows a roamable networking device served by a network (i.e., roamable device network 102) to access IPTV content from the IPTV network 100 in cases where the roamable device network 100 and/or roamable networking device do not support a communication protocol that is compatible with the IPTV network. The IPTV network 100 includes a plurality of service routers 105 and a dispatch server (D-server) 110. Each one of the service routers 105 is situated at or near an edge 112 of the IPTV network 100. The D-server 110 situated within a video hub office (VHO) 115 of the IPTV network 100, although it is disclosed herein that a server that dispatches and/or serves IPTV content need not be situated within the VHO 115.

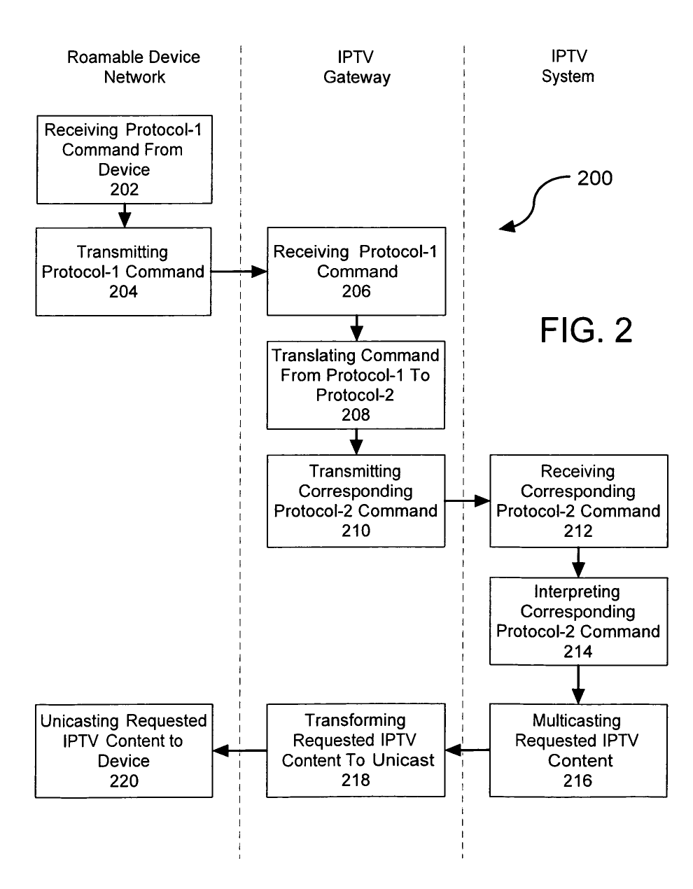

As depicted in FIG. 1, at least one of the service routers 105 includes an IPTV Gateway 120. However, in other embodiments of the present invention, all service routers designated, positioned or functioning as an edge service router within an IPTV network includes an IPTV Gateway. As disclosed above, an IPTV Gateway configured in accordance with the present invention has the functionality of translating commands (e.g., messages) of formats not supported by the IPTV network to commands of a format supported by the IPTV network. In doing so, an IPTV Gateway in accordance with the present invention allows IPTV subscribers to access live IPTV from mobile devices or the Internet while roaming and in a manner that does not increase their access bandwidth consumption. FIG. 2 shows a method 200 for facilitating IPTV Gateway functionality in accordance with an embodiment of the present invention. In one implementation, the method 200 is carried out through the IPTV network 100 shown in FIG. 1. However, the method 200 is not unnecessarily limited to being carried out through any particular network or network architecture. Thus, it is disclosed herein that the functionality provided by the method 200 can be carried out through any suitable network or network architecture and that the labels and steps depicted in FIG. 2 shall not be construed as limiting of any particular or potential implementation of the method 200.

Still referring to FIG. 2, an operation 202 is performed for receiving at a network a protocol-1 formatted command transmitted from a roamable networking device served by the network (i.e., roamable device network) for reception by a designated IPTV system (i.e., an IPTV system of a designated IPTV network). Protocol-1 refers to a communication protocol of the roamable device network, which is not compatible with communication protocols of the IPTV network. Examples of a communication protocol of the roamable device network, which is not compatible with communication protocols of the IPTV network include, but are not limited to, Session Initiation Protocol, Real Time Protocol, Real Time Streaming Protocol and/or Real Time Control Protocol. Examples of the roamable networking device includes, but is not limited to, a laptop computer, a mobile/cell telephone and a wireless personal digital device, and examples of roamable device networks includes at least one of a mobile device network, a wireless telecommunication network and the Internet.

After the protocol-1 formatted command is received by the roamable device network, an operation 204 is performed for transmitting the protocol-1 formatted command for reception by an IPTV Gateway in accordance with the present invention. Such an IPTV Gateway refers to a network element configured for providing IPTV Gateway functionality disclosed above rather than necessarily to any particular type or configuration of physical network equipment. In one specific embodiment of the present invention, the IPTV Gateway is integral with a service router. However, it is disclosed herein that an IPTV Gateway in accordance with the present invention can be integral with other types of servers and switching devices, can operably connected to other types of servers and switching devices and can be provided an operable in a standalone manner.

In response to the IPTV Gateway performing an operation 206 for receiving the protocol-1 formatted command, the IPTV Gateway performs an operation 208 for translating the protocol-formatted command to a corresponding protocol-2 formatted command. Protocol-2 refers to a communication protocol supported by the IPTV network. Internet Group Management Protocol is an example of a communication protocol that is supported by and compatible with the IPTV network. Thus, in one example, the IPTV Gateway translates a Real Time Streaming Protocol formatted SET_UP command to a corresponding Internet Group Management Protocol formatted JOIN command.

It is disclosed herein that the method 200 can be configured to protect IPTV network servers against Denial of Service (DoS) attacks and to protect roamable device access from non-authorized users. In one implementation of such server and device protection, for example, before translating a protocol-1 formatted command to a corresponding protocol-2 formatted command, the IPTV Gateway can perform an operation for checking whether credentials of a roamable networking device (e.g., mobile device) and/or the user to whom the device belongs allow the user and/or roamable networking device to access requested IPTV content. Such checking can include authentication and/or authorization of information associated with the user and/or the roamable networking device.

In response to performing such translating, the IPTV Gateway performs an operation 210 for transmitting the protocol-2 formatted command for reception by the IPTV system. Thereafter, because the protocol-2 command is formatted in accordance with a communications protocol compatible with and supported by the IPTV network, the IPTV system is able to perform an operation 214 for interpreting the protocol-2 formatted command and, thereafter, an operation 216 for multicasting IPTV content for reception by the IPTV Gateway in accordance with the protocol-2 formatted command. In response to receiving the multicast IPTV content, the IPTV Gateway performs an operation 218 for transforming the IPTV content from multicast to unicast format and, in combination therewith, unicasting the IPTV content for reception by the roamable device network. Accordingly, the roamable device network performs an operation 220 for unicasting (i.e., providing) the IPTV content to the roamable networking device having issued the Protocol-1 formatted command.

Advantageously and beneficially, IPTV Gateway functionality in accordance with the present invention can be implemented using one or more existing D-Servers rather than deploying another type of server into the IPTV network for roaming users only. Therefore, implementation of IPTV Gateway functionality in accordance with the present invention is a more cost effective solution than other known solutions that attempt to provide similar between a networking device and IPTV system. IPTV Gateway functionality results in video streams (via multicast) being accessed if, and only if, one or more roaming users are interacting with the IPTV system via wireless/mobile devices and/or networks that do not support a communications protocol that is supported by the IPTV network such that, advantageously and beneficially, no bandwidth is wasted in IPTV network.

Referring now to instructions processible by a data processing device, it will be understood from the disclosures made herein that methods, processes and/or operations adapted for carrying out IPTV Gateway functionality as disclosed herein are tangibly embodied by computer readable medium having instructions thereon that are configured for carrying out such functionality. In one specific embodiment, the instructions are tangibly embodied for carrying out the method 200 disclosed above. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the present invention include a compact disk, a hard drive, RAM or other type of storage apparatus that has imaged thereon a computer program (i.e., instructions) adapted for carrying out IPTV Gateway functionality in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A computer-implemented method, comprising:
receiving a command intended to affect IPTV content transmitted from an IPTV system for reception by a networking device of an IPTV subscriber, wherein said received command is received by an IPTV Gateway apparatus located between the IPTV system and a network serving the networking device and wherein said received command is formatted in accordance with a communications protocol not supported by the IPTV system;
translating said received command to a format in accordance with a communications protocol supported by the IPTV system, wherein said translating is performed by the IPTV Gateway apparatus; and
providing said translated command to the IPTV system after performing said translating, wherein said providing is facilitated by the IPTV Gateway apparatus.

2. The computer-implemented method of claim 1 wherein:
the networking device is one of a laptop computer, a mobile/cellular telephone and a wireless personal digital device; and
the network serving the networking device includes at least one of a mobile device network, a wireless telecommunication network and the Internet.

3. The computer-implemented method of claim 1, further comprising:
facilitating multicasting of said IPTV content from the IPTV system to the IPTV Gateway; and
facilitating unicasting of said IPTV content from the IPTV Gateway for reception by the network serving the networking device.

4. The computer-implemented method of claim 1 wherein:
the communications protocol not supported by the IPTV system is at least one of Session Initiation Protocol, Real Time Protocol, Real Time Streaming Protocol and/or Real Time Control Protocol; and
the communications protocol supported by the IPTV system is Internet Group Management Protocol.

5. The computer-implemented method of claim 4 wherein the communications protocol not supported by the IPTV system is Session Initiation Protocol implemented in combination with one of Real Time Protocol, Real Time Streaming Protocol and/or Real Time Control Protocol.

6. The computer-implemented method of claim 1 wherein:
said received command is a Real Time Streaming Protocol set-up command; and
said translated command is an Internet Group management Protocol join command.

7. The computer-implemented method of claim 6 wherein:
the communications protocol not supported by the IPTV system is at least one of Session Initiation Protocol, Real Time Protocol, Real Time Streaming Protocol and/or Real Time Control Protocol;
the communications protocol supported by the IPTV system is Internet Group Management Protocol;
the networking device is one of a laptop computer, a mobile/cell telephone and a wireless personal digital device; and
the network serving the networking device includes at least one of a mobile device network, a wireless telecommunication network and the Internet.

8. The computer-implemented method of claim 7, further comprising:
facilitating multicasting of said IPTV content from the IPTV system to the IPTV Gateway; and
facilitating unicasting of said IPTV content from the IPTV Gateway for reception by the network serving the networking device.

9. An IPTV network architecture, comprising:
an IPTV system configured for facilitating delivery of IPTV content dependent upon commands formatted in accordance with a communications protocol supported by the IPTV system; and
an edge service router coupled to the IPTV system, wherein the edge service router includes an IPTV Gateway apparatus configured for receiving commands issued by IPTV subscriber networking devices for affecting IPTV content delivered thereto, for translating said commands from a format in accordance with a communications protocol not supported by the IPTV system to said supported communications protocol, and for providing said translated commands to the IPTV system.

10. The IPTV network architecture of claim 9 wherein:
the edge service router is coupled between the IPTV system and a network serving said IPTV subscriber networking devices;
said IPTV subscriber networking devices are selected from a group of IPTV subscriber networking devices comprising laptop computers, mobile/cell telephones and wireless personal digital devices.

11. The IPTV network architecture of claim 9 wherein:
facilitating delivery of IPTV includes multicasting of said IPTV content from the IPTV system to the IPTV Gateway; and
the IPTV Gateway is further configured for unicasting said IPTV content therefrom for reception by a network serving at least a portion of said IPTV subscriber networking devices.

12. The IPTV network architecture of claim 9 wherein:
the communications protocol not supported by the IPTV system is at least one of Session Initiation Protocol, Real Time Protocol, Real Time Streaming Protocol and/or Real Time Control Protocol; and
a communications protocol supported by the IPTV system is Internet Group Management Protocol.

13. The IPTV network architecture of claim 12 wherein the communications protocol not supported by the IPTV system is Session Initiation Protocol implemented in combination with one of Real Time Protocol, Real Time Streaming Protocol and/or Real Time Control Protocol.

14. The IPTV network architecture of claim 9 wherein:
said received commands are Real Time Streaming Protocol set-up commands; and
said translated commands are Internet Group management Protocol join commands.

15. The IPTV network architecture of claim 14 wherein:
facilitating delivery of IPTV includes multicasting of said IPTV content from the IPTV system to the IPTV Gateway;
the IPTV Gateway is further configured for unicasting said IPTV content therefrom for reception by a network serving at least a portion of said IPTV subscriber networking devices;
the communications protocol not supported by the IPTV system is at least one of Session Initiation Protocol, Real Time Protocol, Real Time Streaming Protocol and/or Real Time Control Protocol;
the communications protocol supported by the IPTV system is Internet Group Management Protocol;
the edge service router is coupled between the IPTV system and a network serving said IPTV subscriber networking devices; and
said IPTV subscriber networking devices are selected from a group of IPTV subscriber networking devices comprising laptop computers, mobile/cell telephones and wireless personal digital devices.

16. An IPTV Gateway apparatus configured for:
determining a format of a command intended to affect IPTV content transmitted from an IPTV system for reception by a networking device of an IPTV subscriber;
translating the command to a format in accordance with a communications protocol supported by the IPTV system in response to determining that the command is formatted in accordance with a communications protocol not supported by the IPTV system; and
providing said translated command to the IPTV system.

17. The apparatus of claim 16 being further configured for:
receiving said IPTV content from the IPTV system, wherein said IPTV content is multicast from the IPTV system; and
unicasting of said received IPTV content from the IPTV Gateway for reception by the network serving the networking device.

18. The apparatus of claim 16 wherein:
the communications protocol not supported by the IPTV system is at least one of Session Initiation Protocol, Real Time Protocol, Real Time Streaming Protocol and/or Real Time Control Protocol; and
the communications protocol supported by the IPTV system is Internet Group Management Protocol.

19. The apparatus of claim 18 wherein the communications protocol not supported by the IPTV system is Session Initiation Protocol implemented in combination with one of Real Time Protocol, Real Time Streaming Protocol and/or Real Time Control Protocol.

20. The apparatus of claim 16 wherein:
said determined command is a Real Time Streaming Protocol set-up command; and
said translated command is an Internet Group management Protocol join command.
